(19) United States
(12) Patent Application Publication
(10) Pub. No.: US 2018/0048593 A1
(43) Pub. Date: Feb. 15, 2018

(54) FLOW ENTRY GENERATING AND PACKET PROCESSING BASED ON FLOW ENTRY

(71) Applicant: HEWLETT PACKARD ENTERPRISE DEVELOPMENT LP, Houston, TX (US)

(72) Inventors: Yanjun Tian, Beijing (CN); Hongyuan Wang, Beijing (CN)

(21) Appl. No.: 15/551,557

(22) PCT Filed: Feb. 17, 2016
(86) PCT No.: PCT/CN2016/073914

§ 371 Date: Aug. 16, 2017

(30) Foreign Application Priority Data
Feb. 17, 2015 (CN) 201510085264.6

(51) Int. Cl. H04L 12/935; H04L 12/721

(52) U.S. Cl. CPC H04L 49/3009; H04L 45/38

(57) ABSTRACT

A SDN controller receives a first packet of a flow. The SDN controller generates a flow entry for the flow and generates an offset match field in match field of the flow entry according to an offset matching that is to be performed. The offset match field includes a match position, a match length, a match mask and a match value.

### BACKGROUND

In a Software Defined Network (SDN) network control and forwarding functions of a network device, such as a router and a switch, may be implemented on separate devices. OpenFlow is one example of a standard communication interface defined between the control layer and the forwarding layer in one type of SDN architecture.

An SDN controller, such as an OpenFlow controller, may manage an SDN switch with an SDN protocol. By the SDN protocol, the SDN controller may modify, add, delete, update flow entries in a flow table of the SDN switch. Each flow table of the SDN switch may include multiple flow entries and one table-miss entry. Each flow entry may include the following components: match fields, priority, counters, instructions, timeouts and a cookie.

When finding a flow entry in the flow table matches a packet, the SDN switch may perform processing based on instructions of the matching flow entry. When finding none of flow entries in the flow table matches a packet, the SDN switch may send the packet to the SDN controller, or drop, or continue to look up another flow table based on a table-miss entry in the flow table.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a flow diagram illustrating a method for generating a flow entry based on an example of the present disclosure.

FIG. 2 is a schematic diagram illustrating format of a Virtual eXtensible Local Area Network (VXLAN) packet.

FIG. 3 is a flow diagram illustrating a method for processing a packet based on an example of the present disclosure.

FIG. 4 is a schematic diagram illustrating a network based on an example of the present disclosure.

FIG. 5 is a schematic diagram illustrating a network based on the network shown in FIG. 4 based on an example of the present disclosure.

FIG. 6 is a schematic diagram illustrating a SDN controller based on an example of the present disclosure.

FIG. 7 is a schematic diagram illustrating a SDN switch based on an example of the present disclosure.

### DETAILED DESCRIPTION

Reference will now be made in detail to examples, which are illustrated in the accompanying drawings. In the following detailed description, numerous specific details are set forth in order to provide a thorough understanding of the present disclosure. Also, the figures are illustrations of an example, in which modules or procedures shown in the figures are not necessarily essential for implementing the present disclosure. In other instances, well-known methods, procedures, components, and circuits have not been described in detail so as not to unnecessarily obscure aspects of the examples.

As used herein, the term “includes” means includes but not limited to, the term “including” means including but not limited to. The term “based on” means based at least in part on. In addition, the terms “a” and “an” are intended to denote at least one of a particular element.

In a SDN network, when a protocol between SDN controllers and SDN switches is the OpenFlow protocol, the SDN controllers may be the OpenFlow controllers, and the SDN switches may be the OpenFlow switches. However, the present disclosure is not limited to such and the teachings herein may be applied to other SDN protocols. In a SDN network device, match fields of the components of a flow entry may be used to match an ingress port of a receiving packet, packet header fields of the receiving packet or pipeline fields. The packet header fields may be seemed as packet characteristic information of the receiving packet. The match fields for matching the packet header fields of the receiving may consist of one or more following fields: Ethernet source address, Ethernet destination address, VLAN ID, VLAN priority. IP source address, IP destination address, IP protocol, IP ToS bits, TCP/UDP destination port, TCP/UDP source port, and so on.

The SDN controller may generate match fields of the flow entry based on several packet types which have been supported. However, when receiving an unsupported protocol packet, such as a VXLAN packet or an Ethernet Virtualization Interconnect (EVI) packet, which is not supported by the SDN, the SDN switch cannot identify the protocol packet, and cannot extract the packet header fields based on match fields of the flow entry. This is especially an issue where packets are to be sent via a tunnel and encapsulated or encapsulated. Accordingly, the present disclosure proposes a flexible approach to matching which uses a match offset field.

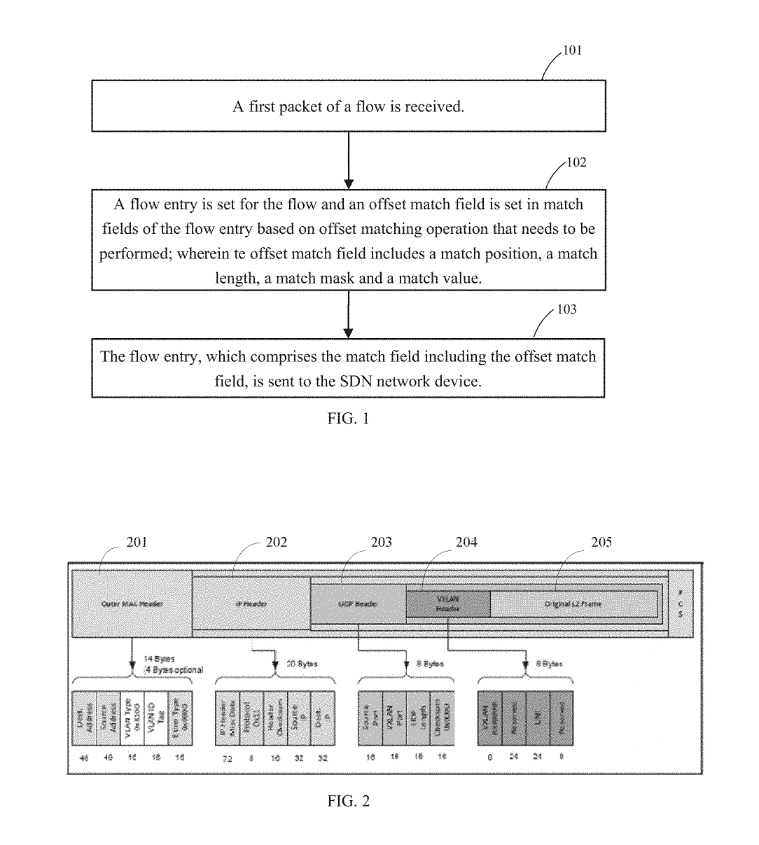

FIG. 1 is a flow diagram illustrating a method for generating a flow entry based on an example of the present disclosure. The method may be applied to the SDN controller, and may include the following processes.

At block 101, a first packet of a flow is received.

When receiving a packet, a SDN network device, such as switch, may search a flow table. When failing to find a matching flow entry, the SDN switch may send the packet as the first packet of a flow to a SDN controller through a control channel, such as an OpenFlow channel, based on a table-miss flow entry. The SDN controller may receive the first packet of the flow.

The first packet at block 101 may be an unsupported protocol packet, such as a VXLAN packet, an EVI packet, or the like, or may be a supported protocol packet, such as an Ethernet packet, an ARP packet, an IPv4 packet, an IPv6 packet and so on.

At block 102, a flow entry is generated for the flow and an offset match field is generated in match fields of the flow entry based on an offset matching operation that needs to be performed. The offset match field may include a match position, a match length, a match mask and a match value.

At block 103, the flow entry, which comprises the match field including the offset match field, is sent to the SDN network device.

The SDN controller may carry the flow entry, which comprises the match field including the offset match field, in an OpenFlow packet, and sent this OpenFlow packet to the SDN network device.

In the present disclosure, the match position is an offset position and is indicated by an offset type and an offset length, and a field may be read from the match position based on the match length. The offset type may be one of the following offset types:

A first offset type, which indicates a first byte of the outermost packet header. The first offset type may be denoted by L1.

A second offset type, which indicates the outermost layer-2 header. The second offset type may be denoted by L2.

A third offset type, which indicates the outermost layer-3 header. The third offset type may be denoted by L3.

A fourth offset type, which indicates the outermost layer-4 header. The fourth offset type may be denoted by L4.

A fifth offset type, which indicates a last bit of the outermost layer-4 header. The fifth offset type may be denoted by L5.

Referring to the format of a VXLAN packet shown in FIG. 2, different offset match fields generated by the SDN controller are described.

The SDN controller receives a VXLAN packet through a control channel, determines to perform offset matching based on a User Networks interface (UNI) field of the VXLAN packet, and sets an offset match field in match fields of the flow entry. For example, the offset match field for the match fields of the VXLAN packet may be {offset type: L4, offset length: L2 bytes, match length: 3 bytes, match mask: 0xFF-FF-FF, match value: 100}.

In FIG. 2, there are 12 bytes between the outermost UDP header 203 and the UNI field of the VXLAN packet, and the UNI field has 3 bytes, so the fourth offset type L4 and the offset length 12 bytes in above mentioned offset match field is the starting byte of the UNI field, and the match length 3 bytes are the length of the UNI field. The match value 100 (namely 01-00-00) is a value used to make a determination about whether it is matched. The match mask 0xFF-FF-FF defines a bit that needs to match the match value. 0x means hexadecimal notation, FF-FF-FF means that each bit of the 3 bytes must be matched. A bit which is 1 in a match mask means that the bit must be matched, and a bit which is 0 in a match mask means that the bit does not need to be matched.

For example, the SDN controller determines to perform offset matching based on the UNI 100 of the VXLAN packet and a destination MAC address (X)-00-00-00-00-02 of an inner Ethernet packet encapsulated in the VXLAN packet, and sets a first offset match field {offset type:L4, offset length: 12 bytes, match length:3 bytes, match mask:0xFF-FF-FF, match value: 100} and a second offset match field{offset type:L4, offset length: 16 bytes, match length:6 bytes, match mask:0xFF-FF-FF-FF-FF-FF, match value:00-00-00-00-02} in match fields of the flow entry.

In FIG. 2, there are 16 bytes between the outermost UDP header 203 and a Ethernet packet 205 (i.e. the original layer-2 frame) of the VXLAN packet, and the first 6 bytes of the Ethernet packet is the Ethernet destination address, so the match position indicated by the fourth offset type L4 and the offset length 16 bytes is the starting byte of the Ethemet packet, and the match length 6 bytes are the length of the Ethernet destination address. The match value 00-00-00-00-00-02 is a value used to make a determination about whether it is matched. The match mask 0xFF-FF-FF-FF-FF-FF defines each bit of the 6 bytes must be matched. 0x means hexadecimal notation.

In the example shown in FIG. 1, the SDN controller may further generate a field for matching the packet header fields in match fields of the flow entry according the OpenFlow protocol.

For example, the SDN controller decides to search the flow table based on the inner Ethernet source MAC address 00-00-00-00-00-01 and the UNI 100 of the VXLAN packet, and perform offset matching based on UNI 100. The SDN controller sets one offset match field and one Ethernet source address field 00-00-00-00-00-01 in match fields of a flow entry. The Ethernet source address field 00-00-00-00-00-01 in the match fields of the flow entry does not act as an offset match field, but is generated in the match fields of the flow entry with the offset match field together.

The SDN controller may send the flow entry to the SDN switch through a control channel. In a SDN running the OpenFlow protocol, the OpenFlow controller may send the flow entry to the OpenFlow switch through the OpenFlow channel.

Based on the method for generating a flow entry shown in FIG. 1, the SDN controller adds an offset match field for matching a packet in match fields of the flow entry, so as to flexibly deploy a new application in the SDN. For instance, the OpenFlow controller may generate an offset match field for matching a packet header field of a supported protocol packet, or for matching an unsupported protocol packet, such as a VXLAN packet or an EVI packet.

In the example shown in FIG. 1, the SDN controller may generate an offset action besides actions including a forwarding action in flow entry instructions. The offset action is used to indicate performing a specified action at a specified position of a packet matching the flow entry. The offset action may be an offset pop action, an offset push action, or an offset modification action.

In the example shown in FIG. 1, when determining that it is required to pop bytes with a specified length from a specified position of a packet matching the flow entry, the SDN controller may generate an offset pop action in instructions of the flow entry. The offset pop action includes a pop position and a pop length. The pop position is an offset position indicted by an offset type and an offset length, and the pop action may be performed from the offset position.

When determining that it is required to push bytes with a specified length which have specified content from a specified position of a packet matching the flow entry, the SDN controller may generate an offset push action in instructions of the flow entry. The offset push action includes a push position, a push length and push content. The push position is an offset position indicted by an offset type and an offset length, and the push action may be performed at the offset position.

When determining that it is required to modify bytes with a specified length at a specified position of a packet matching the flow entry based on specified content, the SDN controller may generate an offset modification action in instructions of the flow entry. The offset modification action includes a modification position, a modification length and modification content. The modification position is an offset position indicted by an offset type and an offset length, and the modification action may be performed starting from the offset position.

FIG. 2 shows an example of a VXLAN encapsulation which includes an outer Ethernet header 201 with the length of 14 bytes, an outer IP header 202 with the length of 20 bytes, an outer UDP header 203 with the length of 8 bytes and a VXLAN header 204 with the length of 8 bytes.

For example, when determining to dencapsulate of the VXLAN packet, the SDN controller may generate an offset pop action {offset type: L1, offset length: 0 byte, pop length: 50 bytes} in instructions of the flow entry. The offset pop action indicates that 50 bytes will be popped starting from the first byte of the VXLAN packet.

For another example, when determining to encapsulate an Ethernet packet with a VXLAN encapsulation, the SDN controller may generate an offset push action {offset type: L1, offset length: 0 byte, push length: 50 bytes, push content: VXLAN encapsulation} in instructions of the flow entry. The offset push action indicates that VXLAN encapsulation with the length of 50 bytes will be pushed starting from the first byte of the Ethernet packet.

In the example shown in FIG. 1, the SDN controller may generate an instruction based on actions defined in the OpenFlow protocol.

It should be noted that when determining to perform both an offset pop operation and an offset push operation on the packet matching the flow entry, the SDN controller may generate the offset pop action first, and then generate the offset push action in operation instructions of the flow entry, or the SDN controller may adopt other methods to enable the offset pop action to be performed before the offset push action.

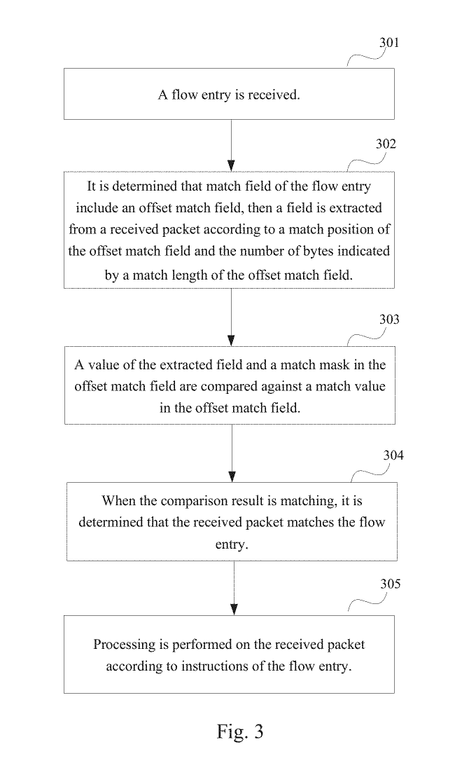

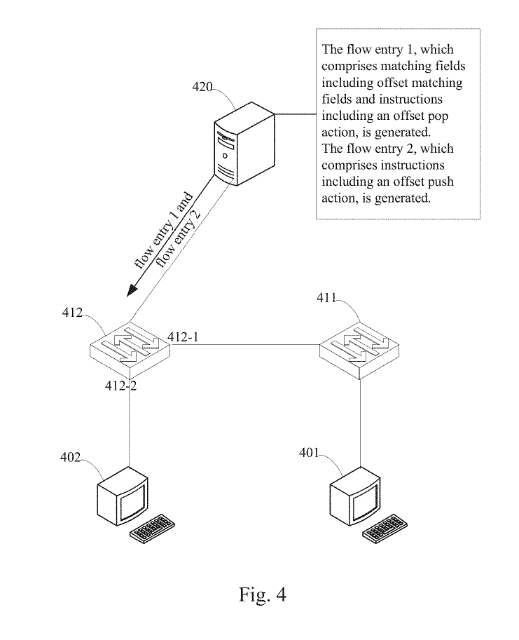

FIG. 3 is a flow diagram illustrating a method for processing a packet according to an example of the present disclosure. The method may be applied to the SDN switch, and may include the following processes.

At block 301, a flow entry is received.

At block 302, it is determined that match fields of the flow entry include an offset match field, then a field is extracted from a received packet according to a match position of the offset match field and the number of bytes indicated by a match length of the offset match field.

At block 303, a value of the extracted field and a match mask in the offset match field are compared against a match value in the offset match field.

At block 304, when above comparison result is matching, it is determined that the received packet matches the flow entry.

At block 305, processing is performed on the received packet according to instructions of the flow entry.

Based on the method for processing a packet shown in FIG. 3, the SDN switch may extract a field from a supported protocol packet or an unsupported protocol packet based on the offset match field, and may perform flow table searching, thus the flexibility of the SDN is enhanced.

In the example shown in FIG. 3, when determining that instructions of the flow entry include an offset pop action, the SDN switch may, based on the pop position indicated by the offset pop action, pop a number of bytes indicated by the pop length of the offset pop action from the received packet.

When determining that instructions of the flow entry include an offset push action, the SDN switch may push a push content of the offset push action having a number of bytes indicated by a push length of the offset push action into a pop position of the receive packet indicated by the offset push action.

When determining that instructions of the flow entry include an offset modification action, the SDN switch may modify a number of bytes indicated by a modification length at a modification position of the received packet indicated by the offset modification action into a modification content indicated by the offset modification action.

FIG. 4 shows a network based on an example of the present disclosure. In FIG. 4, a switch 411 and a host 401 may belong to a network site which is outside the SDN; the switch 411 supports the VXLAN application (namely the switch 411 can identify the VXLAN protocol).

A SDN switch 412 and a host 402 may belong to a network site which is inside the SDN, the SDN switch 412 may run the OpenFlow protocol, but may not support the VXLAN application, namely cannot identify the VXLAN protocol. The SDN switch 412 may sends VXLAN protocol packets for establishing a VXLAN tunnel to the SDN controller 420 through an OpenFlow channel, so as to let the SDN controller 420 to implement VXLAN tunnel establishment proxy for the SDN switch 412.

In a VXLAN network of which VXLAN Network Identifier (VNI) is 100, the switch 411 may use IP address 1.1.1.1 of a port on itself for VXLAN tunnel establishment, and the SDN controller 420 may implement VXLAN tunnel establishment proxy with IP address 2.2.2.2 of an port which is on the SDN switch 412 and connects with the switch 411. A source IP address and a destination address of a VXLAN tunnel connecting the switch 411 to the SDN switch 412 are 1.1.1.1 and 2.2.2.2 respectively. A source IP address and a destination address of VXLAN tunnel connecting the SDN switch 412 to the switch 411 is 2.2.2.2 and 1.1.1.1 respectively.

For the convenience of description, an port on the SDN switch 412 which is used for connecting with the switch 411 is denoted as port 412-1, and an port the SDN switch 412 which is used for connecting with the host 402 is denoted as port 412-2.

The host 401 may send an ARP request packet for requesting MAC address of the host 402. The host 401 sends the ARP request packet based on the ARP protocol. In the ARP request packet, a source MAC address is the MAC address 00-00-00-00-00-01 of the host 401, and a destination MAC address is broadcast MAC address (all-F), a sender MAC address and a sender IP address are MAC address and IP address of the host 401, a target IP address is the IP address of the host 402.

The switch 411 may receive the ARP request packet, and learn a MAC address entry based on the source MAC address. The switch 411 may broadcast the ARP request packet via local ports belong to local network site except a receiving port of the ARP request packet, and send the VXLAN-encapsulated ARP request packet via each VXLAN tunnel (which is not shown in FIG. 4) in the VXLAN network 100, so as to broadcast the ARP request packet in the VXLAN network 100. In the VXLAN-encapsulated ARP request packet which is sent from the switch 411 to the SDN switch 412, a VNI in a VXLAN header 204 is 100, an outer source IP address is the IP address 1.1.1.1, and an outer destination IP address is a multicast IP address.

The SDN switch 412 may receive the VXLAN-encapsulated APR request packet via the port 412-1, encapsulate the VXLAN-encapsulated APR request packet into an OpenFlow packet, and send the OpenFlow packet to the SDN controller 420 (i.e. sending the VXLAN-encapsulated APR request packet to the SDN switch 412 via the OpenFlow channel).

The SDN controller 420 may receive the VXLAN-encapsulated APR request packet via the OpenFlow packet, and learn a MAC address entry based on an inner source MAC address 00-00-00-00-00-01 and the VXLAN tunnel which is indicated by the VNI 100, the outer source IP address 1.1.1.1 and the outer destination IP address 2.2.2.2.

The SDN controller 420 may decapsulate the VXLAN encapsulation, and encapsulate the ARP request packet into a packet out message which may carry an output port 412-2 of the ARP request packet. The SDN controller 420 may send the packet out message to the SDN switch 412. The SDN switch 412 may forward the ARP request packet to the host 402 based on the output port 412-2 carried in the packet out message.

The host 402 receives the ARP request packet, and learns an ARP entry based on the sender IP address and sender MAC address. The host 402 may send an ARP response packet. A source MAC address of the ARP response packet is the MAC address 00-00-00-00-00-02 of the host 402, and the destination MAC address of the ARP response packet is the MAC address 00-00-00-00-00-01 of the host 401.

The SDN switch 412 may receive the ARP response packet via the port 412-2. By processing the ARP response packet as a first packet, the SDN switch 412 may encapsulate the ARP response packet into an OpenFlow packet, and send the OpenFlow packet to the SDN controller 420.

The SDN controller 420 may find the MAC address entry based on the destination MAC address, and encapsulate the ARP response packet into a VXLAN-encapsulated ARP response packet. In the VXLAN-encapsulated ARP response packet, a VNI is 100, a outer source IP address is IP address 2.2.2.2, and a outer destination IP address is 1.1.1.1.

The SDN controller 420 may encapsulate the VXLAN-encapsulated ARP response packet into a packet out message carrying output port 412-1 of the VXLAN-encapsulated ARP response packet and send packet out message to the SDN switch 412. The SDN switch 412 may receive the VXLAN-encapsulated ARP response packet via the packet out message, and sends the VXLAN-encapsulated ARP response packet via the output port 412-1.

The SDN controller 420 may determine to use an ingress port 412-1, an outer IP address 1.1.1.1, an UNI 100 and an inner destination MAC address to search flow table for each of VXLAN packets sent from the switch 411 to the SDN switch 412, to perform offset match operations for the UNI 100 and the inner destination MAC address, to perform an offset pop operation to decapsualte an VXLAN encapsulation; and determine an output port 412-2. The SDN controller 420 may generates a flow entry 1.

In the flow entry 1, match fields may include: an ingress port field 412-1; a source IP address field 1.1.1.1; an offset match field {offset type: L4, offset length: 12 byte, match length:3 bytes, match value: 100, match mask: FF-FF-FF}; an offset match field {offset type: L4, offset length: 16 byte, match length:6 bytes, match value: 00-00-00-00-00-02, match mask: FF-FF-FF-FF-FF-FF}: the instructions include: an offset pop action{offset type: L1, offset length: 0 byte, pop length: 50 bytes}; a forwarding action: forwarding from the output port 412-2.

The SDN controller 420 may determine to use an ingress port 412-2 and an source MAC address to search flow table for each of VXLAN packets sent from the switch 412 to the SDN switch 411, determine to perform an offset push operation for encapsulate an VXLAN encapsulation; and may determine an output port 412-1. The SDN controller 420 may generate a flow entry 2.

In the flow entry 2, match fields include: an ingress port field 412-2; a source MAC address field 00-00-00-00-00-02; instructions include: an offset push action {offset type: L1, offset length: 0 byte, push length: 50 bytes, push content: VXLAN encapsulation}; a forwarding action: forwarding from the output port 412-1.

The SDN controller 420 sends the flow entry 1 and flow entry 2 to the SDN switch 412 through OpenFlow protocol. The SDN switch 412 stores the flow entry 1 and flow entry 2 into a local flow table.

The switch 411 may receive the VXLAN-encapsulated ARP response packet, and learns a MAC address entry based on the inner source MAC address 00-00-00-00-00-02 and the VXLAN tunnel which is indicated by the VNI 100, the outer source IP address 2.2.2.2 and the outer destination IP address 1.1.1.1.

The switch 411 may decapsualte the VXLAN-encapsulated ARP response packet into the ARP response packet, and forward the ARP response packet to the host 401 based on the MAC address entry corresponding to the destination MAC address of the ARP response packet.

The host 401 may receive the ARP response packet, and learn an ARP entry based on the sender MAC address and sender IP address of the ARP response packet.

The host 401 sends an Ethemet data packet to the host 402. The source MAC address of the Ethemet data packet is 00-00-00-00-00-01 and the destination MAC address of the Ethernet data packet is 00-00-00-00-00-02.

The switch 411 may receive the Ethernet data packet, and finds out the MAC address entry corresponding to the destination MAC address, performs VXLAN encapsulation based on the VXLAN tunnel corresponding to the destination MAC address and sends the VXLAN-encapsulated Ethernet data packet. In the VXLAN-encapsulated Ethernet data packet, the VNI is 100, the outer source IP address is the IP address 1.1.1.1, and the outer destination IP address is the IP address 2.2.2.2.

The SDN switch 412 may receive the VXLAN-encapsulated Ethernet data packet via the port 412-1, and find out the flow entry 1 which matches the Ethernet data packet from the local flow table. The processing for the SDN switch 412 to determine that the flow entry 1 matches the VXLAN-encapsulated Ethernet data packet may include: the SDN switch 412 may compares the ingress port field 412-1 with a receiving port 412-1 of the VXLAN-encapsulated Ethernet data packet, and determine that the ingress port matches the receiving port. The SDN switch 412 may, based on the offset match field {offset type: L4, offset length: 12 byte, match length:3 bytes, match value: 100, match mask: FF-FF-FF}, may read the UNI field with the length of 3 bytes starting from the position obtained by offsetting 4 bytes from the outermost UDP header 203 of the VXLAN-encapsulated Ethemet data packet, and compares the value 100 (which may be expressed as 01-00-00) of read UNI field and the match mask FF-FF-FF against the match value 100 (which may be expressed as 01-00-00), and may determine that the UNI value matches the match value. The SDN switch 412 may, based on the offset match field {offset type: L4, offset length: 16 byte, match length:6 bytes, match value: 00-00-00-00-00-02, match mask: FF-FF-FF-FF-FF-FF}, may read the inner Ethernet destination MAC address field with the length of 6 bytes starting from the position obtained by offsetting 16 bytes from the UDP header 203 of the VXLAN-encapsulated Ethernet data packet, may compare the read inner Ethernet destination MAC address 00-00-00-00-00-02 and match mask FF-FF-FF-FF-FF-FF against the match value 00-00-00-00-00-02, and may determine that inner Ethernet destination MAC address matches the match value.

The SDN switch 412 may decapsulate the VXLAN-encapsulated Ethernet data packet based on instructions of the flow entry, and may send the Ethernet data packet to the host 402 via the port 412-2. The process for the SDN switch 412 to decapsulate the VXLAN-encapsulated Ethernet data packet may include: the SDN switch 412, based on the offset pop action {offset type: L1, offset length: 0 byte, pop length: 50 bytes}, pops 50 bytes starting from the first byte of the outermost packet header of the VXLAN-encapsulated Ethernet data packet.

The host 402 may send the Ethernet data packet to the host 401. The source MAC address of the Ethernet data packet is 00-00-00-00-00-02, and the destination MAC address of the Ethemet data packet is 00-00-00-00-00-01.

The SDN switch 412 may receive the Ethernet data packet via the port 412-2, and find the flow entry 2 matching the Ethemet data packet from the local flow table. The process for the SDN switch 412 to determine that the flow entry 2 matches the Ethemet data packet may include: the SDN switch 412 may compare the ingress port field 412-2 with an receiving port 412-2 of the Ethernet data packet, and may determine that the ingress port matches the receiving port: the SDN switch 412 may extract a source MAC address field from the received Ethemet data packet, and determine that extracted source MAC address field matches the source MAC address field in the flow entry 2.

The SDN switch 412 performs VXLAN encapsulation on the received Ethemet data packet based on instructions in the flow entry 2, and sends the VXLAN-encapsulated Ethernet data packet via the output port 412-1. The process for the SDN switch 412 to perform the VXLAN encapsulation may include: based on the offset push action {offset type: L1, offset length: 0 byte, push length: 50 bytes, push content: VXLAN encapsulation}, the SDN switch 412 pushes the VXLAN encapsulation with the length of 50 bytes before the outermost first byte of the received Ethernet data packet.

The switch 411 receives the VXLAN-encapsulated Ethernet data packet, and removes the VXLAN encapsulation, and forwards the Ethemet data packet to the host 401 based on the destination MAC address.

When receiving a ARP request packet, the SDN switch 412 may encapsulate the ARP request packet into an OpenFlow packet, and send the OpenFlow packet to the SDN controller 420. For in order to broadcast the ARP request packet in the VXLAN network, the SDN controller may encapsulate the ARP request packet based on each VXLAN tunnel of the SDN switch 412, encapsulate each VXLAN-encapsulated ARP request packet and a output port of the VXLAN-encapsulated ARP request packet in to a packet out message, and send all the packet out message to the SDN switch 412. The SDN switch 412 may send each VXLAN-encapsulated ARP request packet through its output port.

When receiving a VXLAN-encapsulated ARP response packet, the SDN switch 412 may encapsulate the VXLAN-encapsulated ARP response packet into an OpenFlow packet, and send the OpenFlow packet to the SDN controller 420. The SDN controller 420 may remove the VXLAN encapsulation, encapsulate the ARP response packet and an output port thereof into an packet out message, and send the packet out message to the SDN switch 412. The SDN controller 420 may generate a pair of flow entries for the SDN switch 412. The flow entry for performing VXLAN encapsulation may be generated by referring to the flow entry 2, and the flow entry for performing VXLAN decapsulation may be generated by referring to the flow entry 3.

From the foregoing, the SDN controller 420 deployed a VXLAN application on the SDN switch 412 through the offset match fields or offset actions generated in the flow entry. The SDN switch 412 achieves the VXLAN packet lookup and VXLAN packet forwarding based on the offset match fields and offset actions.

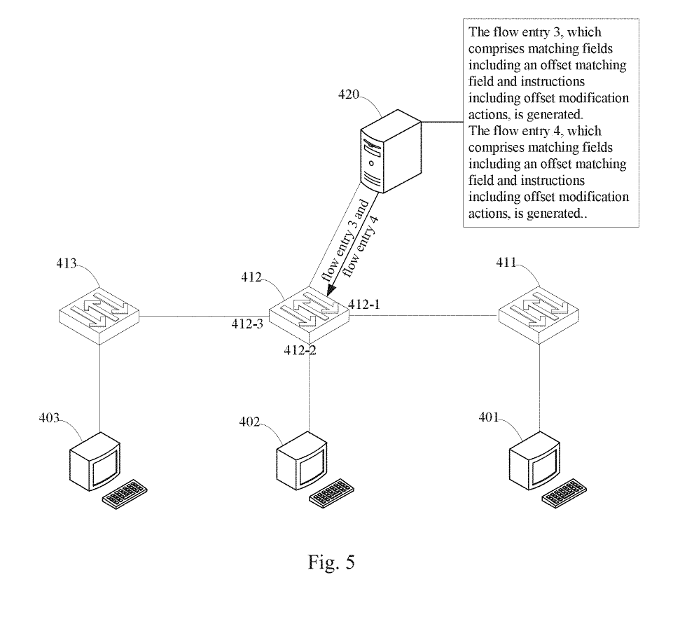

FIG. 5 is a schematic diagram illustrating a network based on the network shown in FIG. 4 based on an example of the present disclosure. In FIG. 5, the network site which the switch 411 and the host 401 belong to and a network site which a switch 413 and a host 403 belong to are outside the SDN, the switches 411 and 413 support the VXLAN. The network site which the SDN switch 412 and the host 402 belong to is inside the SDN. The switch 412 runs the OpenFlow protocol, but does not support the VXLAN. The SDN switch 412 may send a VXLAN protocol packet for establishing a VXLAN tunnel to the SDN controller 420 through an OpenFlow packet, and then the SDN controller 420 may perform VXLAN tunnel establishment proxy for the SDN switch 412.

In FIG. 5, the port connecting the SDN switch 412 with the switch 413 is denoted as port 412-3.

In the VXLAN network of VNI 100, the switch 411 may implement VXLAN tunnel establishment with an IP address 1.1.1.1 an port which is on the SDN switch 412 and connects with the switch 413, and the switch 413 may use an IP address 3.3.3.3 of an port on itself for VXLAN tunnel establishment. A source IP address and a destination IP address of a VXLAN tunnel which connecting the switch 411 to the switch 413 are the IP address 1.1.1.1 and the IP address 3.3.3.3. A source IP address and a destination IP address of a VXLAN tunnel connecting the switch 413 to the switch 411 are the IP address 3.3.3.3 and the IP address 1.1.1.1.

The host 403 may send an ARP request packet for requesting a MAC address of the host 401. The switch 413 may receive the ARP request packet, and learn a MAC address entry based on a source MAC address of the received ARP request packet. The switch 413 may broadcasts the received the received ARP request packet via local ports belonging to the local network site except an receiving port of the received ARP request packet, and send the VXLAN-encapsulated ARP request packets based on each VXLAN tunnel (which is not shown in FIG. 5) in the VXLAN network 100, so as to broadcast the received ARP request packet in the VXLAN network 100. The SDN switch 412 may receive the VXLAN-encapsulated APR request packet via the port 412-3, encapsulate the VXLAN-encapsulated APR request packet into an OpenFlow packet, and send the OpenFlow packet to the SDN controller 420.

The SDN controller 420 may determine use an ingress port 412-3, an UNI 100 and an inner destination MAC address to search flow table searching for VXLAN packets sent from the switch 413 to the switch 411, determine to perform an offset match operation for the UNI 100 and the inner destination MAC address, determine to perform an offset modification operation for an outermost destination MAC address, an outermost source MAC address, and an outermost VLAN tag of each of the VXLAN packets sent from the switch 413 to the switch 411; determine the VXLAN packets sent from the switch 413 to the switch 411 are forwarded via an output port 412-1. The SDN controller 420 may generate flow entry 3, and may send the flow entry 3 to the SDN switch 412 through the OpenFlow protocol. The SDN switch 412 may store the flow entry 3 in the local flow table.

The SDN switch 412 does not support VXLAN. The SDN controller 420 sets the offset modification action based on the next hop reaching the destination IP address of a VXLAN tunnel, to enable the SDN switch 412 to modify the outermost destination MAC address, the outermost source MAC address, and the outermost VLAN tag of the VXLAN packet.

In the flow entry 3, match fields include: an ingress port field 412-3; an offset match field {offset type: L4, offset length: 12 bytes, match length:3 bytes, match value: 100, match mask: FF-FF-FF}; an offset match field {offset type: L4, offset length: 16 bytes, match length:6 bytes, match value: 00-00-00-00-00-01, match mask: FF-FF-FF-FF-FF-FF}; the instructions include: an offset modification action{offset type: L1, offset length: 0 byte, modification length: 6 bytes, modification content: an new outermost destination MAC address}; an offset modification action{offset type: L1, offset length: 6 bytes, modification length: 6 bytes, modification content: an new outermost source MAC address}; an offset modification action{offset type: L1, offset length: 14 bytes, modification length: 2 bytes, modification content: an new outermost VLAN tag}; a forwarding action: forwarding through the output port 412-1.

The SDN switch 412 may search the flow table, and find the flow entry 3 matching the VXLAN-encapsulated ARP request packet. Based on the instructions of the flow entry 3, the SDN switch 412 may modify the outermost destination MAC address, the outermost source MAC address, and the outermost VLAN tag of the VXLAN-encapsulated ARP request packet with the new outermost destination MAC address, the new outermost source MAC address, and new the outermost VLAN tag, and send the VXLAN-encapsulated ARP request packet via the output port 412-1.

The switch 411 may receive the VXLAN-encapsulated ARP response packet, and learn a MAC address entry based on an inner source MAC address 00-00-00-00-00-03 and the VXLAN tunnel which may be indicated by an VNI 100, an outer source IP address 3.3.3.3 and an outer destination IP address 1.1.1.1. The switch 411 may encapsulate the VXLAN-encapsulated ARP request packet in to the ARP request packet, and broadcasts the ARP response packet via local ports belonging to the local network site, so that the ARP request packet will be received by host 401. The host 401 may performs learn an ARP entry, and send an ARP response packet.

The switch 411 may receive the ARP response packet, find the MAC address entry of the destination MAC address 00-00-00-00-00-03, perform VXLAN encapsulation for the ARP response packet based on a corresponding VXLAN tunnel in the found MAC address entry, and send a VXLAN-encapsulated ARP response packet. In the VXLAN-encapsulated ARP response packet, an VNI is 100, an outer source IP address is IP address 1.1.1.1, and an outer destination IP address is 3.3.3.3.

The SDN switch 412 may receive the VXLAN-encapsulated ARP response packet via the port 412-1, encapsulate the ARP response packet into an OpenFlow packet, and send the OpenFlow packet to the SDN controller 420.

The SDN controller 420 may determine to use an ingress port 412-1, an UNI 100 and an inner destination MAC address to search the local flow table, determine an offset match operation for the UNI 100 and an offset match operation for an inner destination MAC address, determine to perform an offset modification operations to change an outermost destination MAC address, an outermost source MAC address, and an outermost VLAN tag in VXLAN packets sent form the switch 411 to the switch 411, and determine an output port 412-3. The SDN controller 420 may generate a flow entry 4, and sends the flow entry 4 to the SDN switch 412 via an OpenFlow protocol packet. The SDN switch 412 may store the flow entry 4 in the local flow table.

In the flow entry 4, match fields include: an ingress port field 412-1; an offset match field {offset type: L4, offset length: 12 bytes, match length:3 bytes, match value: 100, match mask: FF-FF-FF}: an offset match field {offset type: L4, offset length: 16 bytes, match length:6 bytes, match value: 00-00-00-00-00-03, match mask: FF-FF-FF-FF-FF-FF}; the instructions include: an offset modification action{offset type: L1, offset length: 0 byte, modification length: 6 bytes, modification content: an newt destination MAC address}; an offset modification action{offset type: L1, offset length: 6 bytes, modification length: 6 bytes, modification content: an new outermost source MAC address}; an offset modification action{offset type: L1, offset length: 14 bytes, modification length: 2 bytes, modification content: an new outermost VLAN tag}; a forwarding action: forwarding through the output port 412-3.

The SDN switch 412 may search its flow table; find the flow entry 4 matching the VXLAN-encapsulated ARP response packet. Based on the instructions of the flow entry 4, the SDN switch 412 may modify the outermost destination MAC address, the outermost source MAC address, and the outermost VLAN tag in the VXLAN-encapsulated ARP response packet, and forward the VXLAN-encapsulated ARP response packet via the output port 412-3.

The switch 413 may receive the VXLAN-encapsulated ARP response packet, decapsulate the VXLAN encapsulation VXLAN-encapsulated ARP response packet in to the ARP response packet, find the MAC address entry of the destination MAC address of the ARP response packet, and send the ARP response packet to the host 403. The host 403 may learn an ARP entry.

It should be noted that, the offset pop action, the offset push action and the offset modification action may serve as apply actions and can be executed immediately when a matching flow entry is found; or the offset pop action, the offset push action and the offset modification action may serve as write action and can be executed after matching flow entries in multi-level flow tables are found. The offset match operations can be flexibly set, and not limited by the present disclosure.

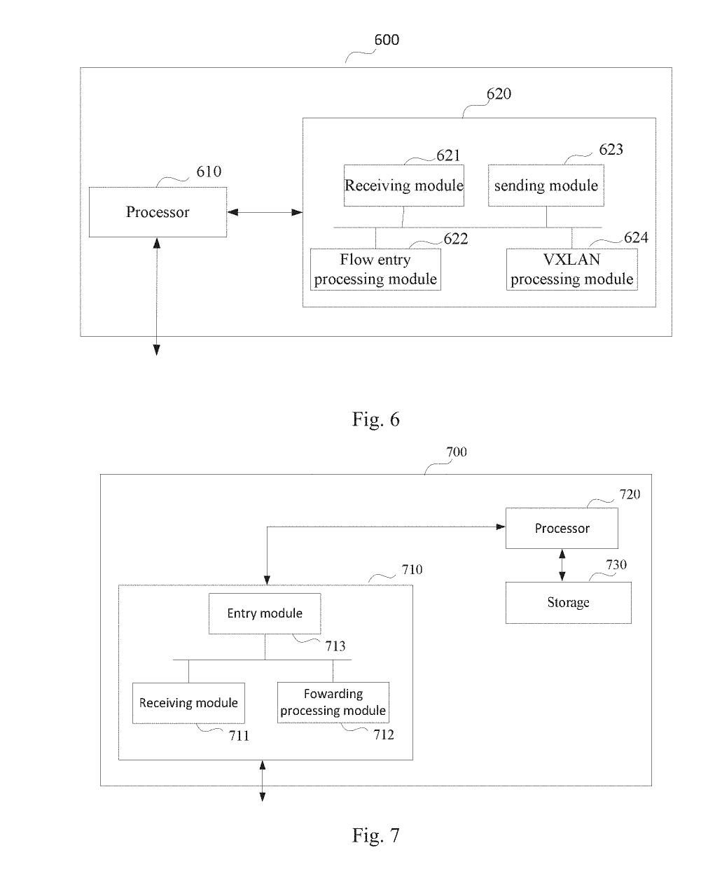

FIG. 6 is a schematic diagram illustrating a SDN controller based on an example of the present disclosure. As shown in FIG. 6, the SDN controller may include a port, a processor 610 and a memory 620. The memory 620 may be a non-transitory storage medium and may store multiple coding modules which may be machine readable instructions that are executable by the processor 610. The multiple coding modules of the memory 620 may include a receiving module 621, a flow entry processing module 622, a sending module 623 and a VXLAN processing module 624.

An OpenFlow packet may be received via the port. The OpenFlow packet may carry protocol packets and data packets and maybe sent to the processor 610 to be processed.

The receiving module 621 may receive a first packet of a flow. The first packet of the flow may be encapsulated in an OpenFlow packet which may be sent from a SDN network device.

The flow entry processing module 622 may generate a flow entry for the flow and generate an offset match field in match fields of the flow entry based on an offset matching operation that needs to be executed. The offset match field may include a match position, a match length, a match mask and a match value. The match position is an offset position, and is indicated by an offset type and an offset length, and a field may be read from the match position based on the match length.

The flow entry processing module 622 may further determine an offset pop operation to be performed and generate an offset pop action in instructions of the flow entry based on the offset pop operation. The offset pop action may indicate a pop position and a pop length. The pop position is an offset position, and is indicted by an offset type and an offset length, and the pop action may be performed from the pop position.

The flow entry processing module 622 may further determine an offset push operation to be performed and generate an offset push action in the instructions of the flow entry based the offset push operation. The offset push action may indicate a push position, a push length and a push content. The push position is an offset position from where the push action is to be performed, and can be indicted by an offset type and an offset length.

The flow entry processing module 622 may further determine an offset modification operation to be performed and generate an offset modification action in instructions of the flow entry based on the offset modification operation. The offset modification action indicates a modification position, a length of a modification field and a value of the modification field.

The sending module 623 may send the generated flow entry to the SDN network device. The sending module 623 may carry the flow entry in an OpenFlow packet, and send the OpenFlow packet carrying the flow entry to the SDN network device via the port.

A VXLAN packet encapsulated within an OpenFlow packet or an ARP packet encapsulated within the OpenFlow protocol may be received via the port, and the VXLAN packet encapsulated within an OpenFlow packet or the ARP packet encapsulated within an OpenFlow protocol may be transmitted to the processor 610. The processor 610, by executing the VXLAN processing module 624 in the memory 620, may implement VXLAN tunnel establishment proxy and forward ARP protocol packets in the VXLAN.

For example, when determining that a VXLAN packet carried in an OpenFlow packet is used for VXLAN tunnel establishment, the VXLAN processing module 624 may implement VXLAN tunnel establishment proxy. The VXLAN processing module 624 may generate a VXLAN packet for establishing a VXLAN tunnel connecting to a VXLAN Tunneling End Point (VETP).

When determining an ARP protocol packet is carried in an OpenFlow packet and is to be forwarded in the VXLAN network, the VXLAN processing module 624 may perform VXLAN encapsulation based on a VXLAN tunnel of a VXLAN network which the ARP protocol packet belongs to, and send the VXLAN-encapsulated ARP packet and a output port thereof to the sending module 623. The sending module 623 may encapsulate the VXLAN-encapsulated ARP packet and the output port thereof in an OpenFlow packet, and send the OpenFlow packet carrying the VXLAN-encapsulated ARP packet and the output port thereof to the SDN network device through the port.

When determining a VXLAN-encapsulated ARP protocol packet is carried in an OpenFlow packet and is to be decapsulated and forwarded, the VXLAN processing module 624 may decapsulate the VXLAN encapsulation, and send the ARP protocol packet and an output port of the ARP protocol packet to the sending module 623. The sending module 623 may encapsulate the ARP protocol packet and the output port thereof in an OpenFlow packet, and send the OpenFlow packet carrying the ARP protocol packet and the output port thereof to the SDN network device through the port. The VXLAN processing module 624 may learn a MAC address entry based on a VXLAN encapsulation of an ARP protocol packet.

In the example shown in FIG. 6, the offset types may include: A first offset type, which indicates a first byte of the outermost packet header. A second offset type, which indicates the outermost layer-2 header. A third offset type, which indicates the outermost layer-3 header. A fourth offset type, which indicates the outermost layer-4 header. A fifth offset type, which indicates a last bit of the outermost layer-4 header.

FIG. 7 is a schematic diagram illustrating a SDN network devices based on an example of the present disclosure. The SDN network device may be a router or may be an SDN switch. As shown in FIG. 7, the SDN network device may include a port, a forwarding unit 710, a processor 720 and a memory 730. The forwarding unit 710 may include: a receiving module 711, a forwarding processing module 712 and an entry module 713. The forwarding unit 710 may be implemented by an Application Specific Integrated Circuit (ASIC) or by a Field-Programmable Gate Array (FPGA). For example the forwarding unit and modules therein may be implemented by hardware logic, a processor executing machine readable instructions or a combination thereof. The memory unit 730 includes multiple coding modules which may be executed by the processor 720.

The receiving module 711 may receive a flow entry which may be carried in an OpenFlow packet, and then the forwarding processing module 712 may record the flow entry into a corresponding flow table in the entry module 713. The receiving module 711 may receive a packet to be forwarded, and then the forwarding processing module 712 may perform lookup in the flow table.

The forwarding processing module 712 may determine that match fields of the flow entry include an offset match field, extract a field from a received packet based on a match position of the offset match field and a number of bytes indicated by a match length of the offset match field, compare a value of the extracted field and a match mask of the offset match field against a match value of the offset match field, determine the received packet matches the flow entry when a comparison result is matching, and perform processing on the received packet based on instructions of the flow entry.

The forwarding processing module 712 may further, based on the pop position indicated by an offset pop action in instructions of the flow entry, pop a number of bytes indicated by a pop length of the offset pop action from the received packet.

The forwarding processing module 712 may further, based on a push position indicated by an offset push action in instructions of the flow entry and a number of bytes indicated by a push length push the push content of the offset push action into the received packet.

The forwarding processing module 712 may further, based on a modification length and a modification position indicated by offset modification action in instructions of the flow entry, modify a number of bytes of the received packet, with a modification content indicated by the offset modification action.

The forwarding processing module 712 may further perform processing based on actions defined by the OpenFlow protocol in instructions of the flow entry.

When failing to find a flow entry in the flow table stored in the entry module 713, the forwarding processing module 712 may encapsulate the received packet without a matching flow entry into an OpenFlow packet, and send the OpenFlow packet to a SDN controller. The receiving module 711 may receive a VXLAN packet, and then the forwarding processing module 712 may encapsulate the VXLAN packet into an OpenFlow packet, and send the OpenFlow packet to the SDN controller. The receiving module 711 may receive an OpenFlow packet in which a VXLAN packet and an output port thereof are encapsulated, and then the forwarding processing module 712 may send the VXLAN packet based on the output port of the VXLAN packet. The receiving module 711 may receive an OpenFlow packet in which an ARP packet and an output port thereof are encapsulated, and then the forwarding processing module 712 may send the ARP packet based on the output port of the ARP packet.

Besides the VXLAN packet, technical solutions in examples shown in FIG. 4˜FIG. 7 also apply to other protocol packets which are not supported by the SDN, such as an EVI packet. The offset match and offset action provided by the present disclosure may achieve the forwarding of supported protocol packet or unsupported protocol packet in the SDN, thus the SDN flexibility is enhanced.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

The above examples may be implemented by hardware, software, firmware, or a combination thereof. For example the various methods, processes and functional modules described herein may be implemented by a processor (the term processor is to be interpreted broadly to include a CPU, processing unit/module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. The modules, if mentioned in the aforesaid examples, may be combined into one module or further divided into a plurality of sub-modules. Further, the examples disclosed herein may be implemented in the form of a software product. The computer software product is stored in a non-transitory storage medium and comprises a plurality of instructions for making an electronic device implement the method recited in the examples of the present disclosure.

What is claimed is:

1. A method for generating a flow entry by a Software Defined Network (SDN) controller, the method comprising:
receiving, by the SDN controller, a first packet of a flow; and
generating, by the SDN controller, a flow entry for the flow and generating an offset match field in a match field of the flow entry based on offset matching operation that is to be performed; the offset match field including a match position, a match length, a match mask and a match value; and
sending, by the SDN controller, the flow entry to a SDN network device, the flow entry comprising the match field which include offset match field.

2. The method according to claim 1, before sending the flow entry to a SDN network device, the method further comprising:
generating, by the SDN controller, an offset pop action in instructions of the flow entry based on an offset pop operation to be performed; the offset pop action indicating a pop position and a pop length.

3. The method according to claim 1, before sending the flow entry to a SDN network device, the method further comprising:
generating, by the SDN controller, an offset push action in instructions of the flow entry based on an offset push operation to be performed; the offset push action indicates a push position, a push length and push content.

4. The method according to claim 1, before sending the flow entry to a SDN network device, the method further comprising:
generating, by the SDN controller, an offset modification action in instructions of the flow entry based on an offset modification operation to be performed; the offset modification action indicates a modification position, a modification length and a modification content.

5. A method for processing a packet by a Software Defined Network (SDN) network device, comprising:
receiving, by the SDN network device, a flow entry:
determining, by the SDN network device, that match field of the flow entry comprise an offset match field, extracting a field from a received packet based on a match position of the offset match field and the number of bytes indicated by a match length of the offset match field;
comparing, by the SDN network device, a value of extracted field and a match mask of the offset match field against a match value of the offset match field, when the value of the extracted field matches the match value, determining that the received packet matches the flow entry; and
performing, by the SDN network device, processing on the received packet based on instructions of the flow entry.

6. The method according to claim 5, when the instructions of the flow entry comprise an offset pop action, wherein performing processing on the received packet comprises:
based on the pop position indicated by the offset pop action, popping, by the SDN network device, a number of bytes corresponding to a pop length indicated by the offset pop action from the received packet.

7. The method according to claim 5, when the instructions of the flow entry comprise an offset push action, wherein performing processing on the received packet comprises:
based on the push position indicated by the offset push action, pushing, by the SDN network device, a push content of the offset push action into the received packet; where in the push content has a number of bytes corresponding to a push length of the offset push action.

8. The method according to claim 5, when the instructions of the flow entry comprise an offset modification action, wherein performing processing on the received packet comprises:
based on the modification position indicated by the offset modification action, modifying, by the SDN network device, a number of bytes, in the received packet, of which the number is indicated by a modification length of the offset modification action with a modification content indicated by the offset modification action.

9. A Software Defined Network (SDN) controller comprising:
a processor and a non-transitory machine readable storage medium storing instructions that are executable by the processor to:
receive a first packet of a flow; and
generate a flow entry for the flow and generate an offset match field in the match field of the flow entry based on offset matching operation that needs to be performed; the offset match field comprises a match position, a match length, a match mask and a match value.

10. The SDN controller according to claim 9, the non-transitory machine readable storage medium further comprising instructions to:
generate an offset pop action in instructions of the flow entry based on an offset pop operation to be performed; the offset pop action indicates a pop position and a pop length.

11. The SDN controller according to claim 9, the non-transitory machine readable storage medium further comprising instructions to:
generate an offset push action in instructions of the flow entry based on an offset push operation to be performed; the offset push action indicates a push position, a push length and a push content.

12. The device according to claim 9, the non-transitory machine readable storage medium further comprising instructions to:
generate an offset modification action in instructions of the flow entry based on an offset modification operation to be performed; the offset modification action indicates a modification position, a modification length and a modification content.

13. A Software Defined Network (SDN) network device comprising:
a receiving module, to receive a flow entry:
an entry module, to record the flow entry received by the receiving module;
a forwarding processing module, to determine that match field of the flow entry comprise an offset match field, extract a field from a received packet based on a match position of the offset match field and the number of bytes indicated by a match length of the offset match field; compare a value of the extracted field and a match mask of the offset match field against a match value of the offset match field, when the value of the extracted field matches the match value, determine that the received packet matches the flow entry; and perform processing on the received packet based on instructions of the flow entry.

14. The SDN network device according to claim 13, wherein the forwarding processing module is further to:
based on the pop position indicated by the offset pop action, pop bytes of which the number corresponds to the pop length indicated by the offset pop action from the received packet.

15. The SDN network device according to claim 13, wherein the forwarding processing module is further to:
based on the push position indicated by the offset push action, push the push content into the received packet; wherein the push content has a number of bytes indicated by a push length of the offset push action; and/or
based on the modification position indicated by the offset modification action, modify the bytes of which the number is indicated by a modification length of the offset modification action with modification content indicated by the offset modification action.
